(19) United States
(12) Patent Application Publication
(10) Pub. No.: US 2015/0095152 A1
(43) Pub. Date: Apr. 2, 2015

(54) SOCIAL NETWORK CONNECTION-DRIVEN PRODUCT PROMOTION

(71) Applicant: Yuno, LLC., Charlotte, NC (US)

(72) Inventors: Andre Shawn WALTERS, Charlotte, NC (US); Wayne Edwards NILSEN, Charlotte, NC (US)

(21) Appl. No.: 14/503,495

(22) Filed: Oct. 1, 2014

Related U.S. Application Data
(60) Provisional application No. 61/885,087, filed on Oct. 1, 2013.

(51) Int. Cl. G06Q 30/02; G06Q 50/00

(52) U.S. Cl. CPC G06Q 30/0255; G06Q 30/0273; G06Q 30/0274; G06Q 50/01
USPC 705/14.53

(57) ABSTRACT

Computerized systems and computerized methods are provided for social network connection-driven product promotion. Data is received from a first remote computing device indicative of a purchase of an offer from a merchant, wherein the data is associated with a user and includes a purchase price for the offer. A set of social network contacts of the user is determined. Data associated with a set of user accounts for one or more contacts is updated to include the offer from the merchant, so that a user associated with an updated user account is presented with the offer from the merchant. Second data is received from a second remote computing device indicative of a second purchase of the offer from the merchant. A credit for a portion of the purchase price is added to a user account to reduce the purchase price paid by the user.

### RELATED APPLICATIONS

This application relates to and claims priority under 35 U.S.C. §119(e) to U.S. provisional patent application No. 61/885,087, filed on Oct. 1, 2013, which is hereby incorporated herein by reference in its entirety.

### FIELD

The subject matter disclosed in this application generally relates to social network connection-driven product promotion.

### BACKGROUND

In today's social networking environment, people often connect to a great number of friends and family, but the framework for these connections is usually not specifically designed to encourage product referral and influence patterns of purchase.

In today's marketing environment, traditional methods of marketing and advertising are increasingly less effective, more expensive, less trusted, and produce lower returns on investment. Two-thirds of the US economy is now driven by referral. Ten percent of the population influences the purchasing behaviors of the other ninety percent. However, this ten percent of the population is not well-utilized to promote products, such as in a social networking environment.

### SUMMARY

The apparatus and computerized methods disclosed herein relate to computerized systems and computerized methods to capitalize on the strength of one's social network. The techniques can be used to activate the purchasing power of an individual's social network and can transform the way people connect and buy products and services.

In some embodiments, a computerized method for social network connection-driven product promotion is provided. A computing device receives data from a first remote computing device indicative of a purchase of an offer from a merchant, wherein the data is associated with a user and includes a purchase price for the offer. The computing device determines a set of social network contacts of the user based on a social network for the user stored in a database in communication with the computing device. The computing device updates data associated with a set of user accounts for one or more contacts from the set of social network contacts stored in the database to include the offer from the merchant, so that a user associated with an updated user account is presented with the offer from the merchant. The computing device receives second data from a second remote computing device indicative of a second purchase of the offer from the merchant, wherein the second data is associated with an updated user account from the set of user accounts. The computing device adds a credit for a portion of the purchase price to a user account associated with the user so that the purchase price paid by the user is reduced in response to the second purchase by a contact from the set of social network contacts of the user.

In some embodiments, a computing system is configured to provide social network connection-driven product promotion. The computing system includes a database and a processor in communication with the database. The processor is configured to run a module stored in memory that is configured to cause the processor to receive data from a first remote computing device indicative of a purchase of an offer from a merchant, wherein the data is associated with a user and includes a purchase price for the offer. The module stored in memory that is configured to cause the processor to determine a set of social network contacts of the user based on a social network for the user stored in the database. The module stored in memory that is configured to cause the processor to update data associated with a set of user accounts for one or more contacts from the set of social network contacts stored in the database to include the offer from the merchant, so that a user associated with an updated user account is presented with the offer from the merchant. The module stored in memory that is configured to cause the processor to receive second data from a second remote computing device indicative of a second purchase of the offer from the merchant, wherein the second data is associated with an updated user account from the set of user accounts. The module stored in memory that is configured to cause the processor to add a credit for a portion of the purchase price to a user account associated with the user so that the purchase price paid by the user is reduced in response to the second purchase by a contact from the set of social network contacts of the user.

In some embodiments, a non-transitory computer readable medium is provided, having executable instructions operable to cause an apparatus to receive data from a first remote computing device indicative of a purchase of an offer from a merchant, wherein the data is associated with a user and includes a purchase price for the offer. The executable instructions are operable to cause an apparatus to determine a set of social network contacts of the user based on a social network for the user stored in the database. The executable instructions operable to cause an apparatus to update data associated with a set of user accounts for one or more contacts from the set of social network contacts stored in the database to include the offer from the merchant, so that a user associated with an updated user account is presented with the offer from the merchant. The executable instructions operable to cause an apparatus to receive second data from a second remote computing device indicative of a second purchase of the offer from the merchant, wherein the second data is associated with an updated user account from the set of user accounts. The executable instructions operable to cause an apparatus to add a credit for a portion of the purchase price to a user account associated with the user so that the purchase price paid by the user is reduced in response to the second purchase by a contact from the set of social network contacts of the user.

In some embodiments, members intentionally leverage their relationships in order to capitalize on their social network (“social capital”) and save on the products and services they prefer. The size of an individual's network and their ability to influence their network to buy certain products and services can persuade a merchant within the system to send that individual their best offers. The system can be configured to provide “networked-influencers” the opportunity to benefit from the full value of their social capital.

In some embodiments, for merchants, the system is designed to harness the power of electronic social network marketing (e.g., electronically through social networking channels). Since only ten percent of the population is often the most influential, a customer's willingness to share their purchases, size of their network, and ability to influence their circle of friends and family holds tremendous marketing value. The techniques disclosed herein can tap into the individual's social capital and transform the way merchants sell products and services.

In some embodiments, merchants connect directly to customers who have expressed a preference to buy products and services from the applicable merchant. Merchants can entice these particular customers to buy through targeted promotions and/or discounts. Once a member buys a product or service in response to the aforementioned targeted promotion and/or discount, the member can (e.g., instantaneously and automatically, if configured in the system) share the promotion with their connections. As each member of that member's network buys the product or service using the same promotion, the initial purchaser can receive additional rewards and value. This process can repeat as the particular promotion and/or discount gets shared with other networks connected in some way to the initial purchaser.

These and other capabilities of the disclosed subject matter will be more fully understood after a review of the following figures and detailed description. It is to be understood that the phraseology and terminology employed herein are for the purpose of description and should not be regarded as limiting.

### BRIEF DESCRIPTION OF THE FIGURES

Various objectives, features, and advantages of the disclosed subject matter can be more fully appreciated with reference to the following detailed description of the disclosed subject matter when considered in connection with the following drawings, in which like reference numerals identify like elements.

FIG. 1A is an exemplary diagram of a system for social network connection-driven product promotion, according to some embodiments.

FIG. 1B is an exemplary diagram that describes the system's usage of the chain model as it applies to the member cash back and offer propagation algorithm using the system shown in FIG. 1A, according to some embodiments.

FIG. 2 is an exemplary schematic diagram of a collection of members rooted at member A interacting with an offer, according to some embodiments.

FIG. 3 is an exemplary flow diagram that demonstrates the stream of information between the layers of the system, according to some embodiments.

FIG. 4 is an exemplary diagram of a potential interest tree to which the system can assign probabilities of interest, according to some embodiments.

FIG. 5 is an exemplary chart of possible discount curves based on the normal CDF with different values for μ and σ, according to some embodiments.

FIG. 6 is an exemplary chart of possible fee structures for merchants based on the normal CDF with different values for μ and σ corresponding to the values from FIG. 5, according to some embodiments.

FIG. 7 is an exemplary diagram that depicts the system's use of location based targeting, according to some embodiments.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

According to the techniques described herein, a consumer makes a commitment to buy an item at a specified value. Then, leveraging their social capital, they may increase their discount (which increased value is provided to the member in various forms) by influencing others to purchase. In some examples, different approaches can be used to influence scorekeeping, including (1) the chain model and/or (2) the hub and spoke model. In an exemplary embodiment, this system focuses on the chain model, however a person of skill in the art will appreciate that the techniques are not limited to just these approaches.

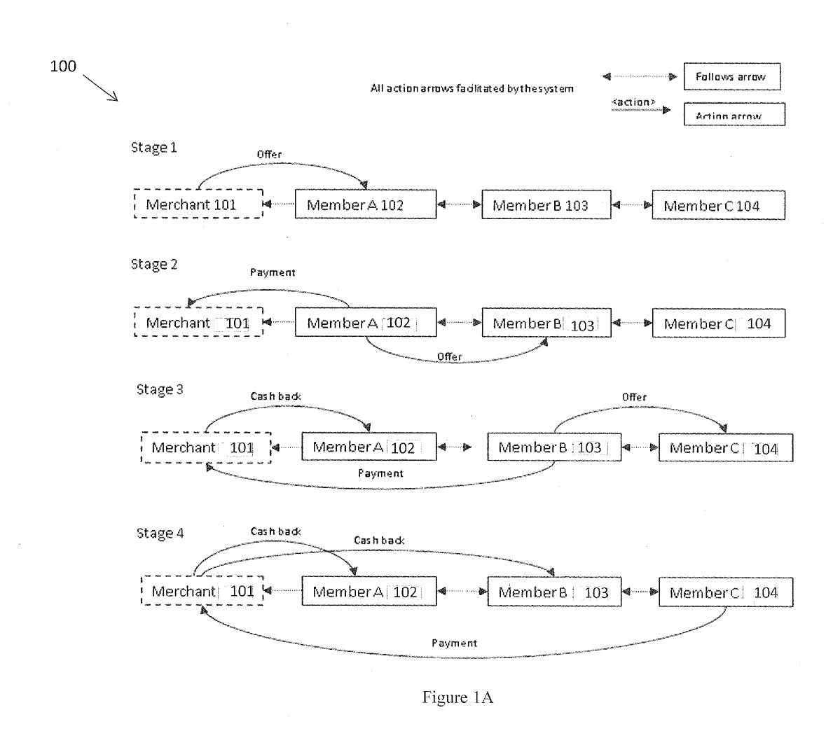

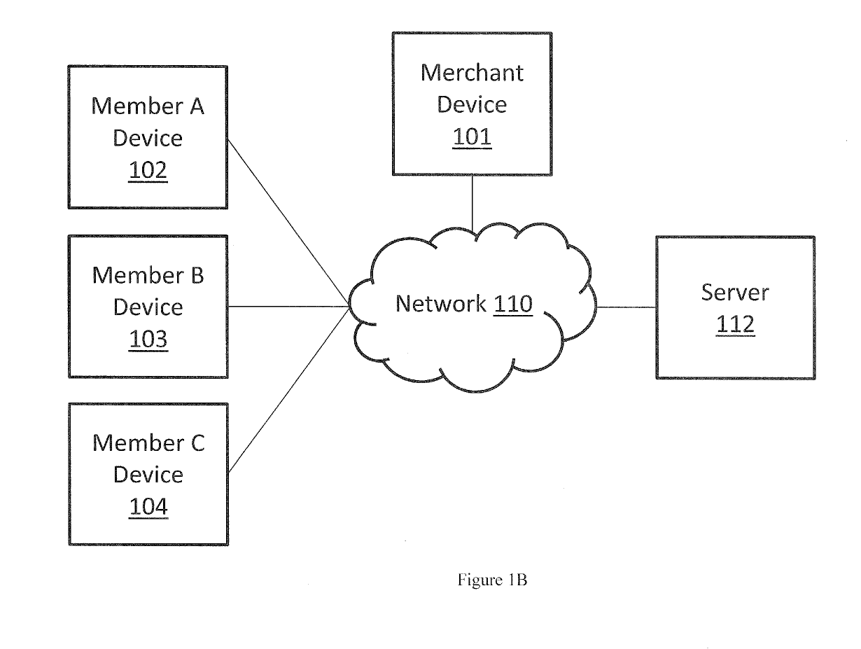

FIG. 1A is an exemplary diagram of a system for social network connection-driven product promotion, according to some embodiments. FIG. 1B shows member A device 102, member B device 103, and member C device 104 connected to the server 112 via network 110. Merchant device 101 is also connected to the server 112 via network 110. FIG. 1B is an exemplary diagram 100 that describes usage of a chain model as it applies to the member cash back and offer propagation algorithm by the system shown in FIG. 1A, according to some embodiments. For exemplary purposes, the diagram 100 illustrates a simplified example containing three members, member A 102, member B 103 and member C 104. Member A 102 is connected to member B 104, and member B 104 is connected to member C 106. Member A 102 is not connected directly to member C 106.

At stage 1, merchant 101 electronically makes an offer to user A 102 for the purchase of discounted merchandise by means of the heat map mechanism. For example, the offer can be presented in a web page or software application that displays the offer. The merchant 101 can send the offer to the server 112, which then distributes the offer to the member devices. At stage 2, A 102 electronically engages in the offer made to him/her (e.g., and potentially made to others) by a merchant for the purchase of discounted merchandise. For example, member A 102 can click a “purchase” button in the electronic offer presented from the merchant 101. In this very simple scenario, A 102 is only connected to B 103 (e.g., through electronic social networking connections) so that is the only person that they can influence. B 103 is notified through the system that A 102 has engaged in the offer. The offer that B 103 is receiving is fully transparent and exactly the same as the one that was offered to A 102.

At stage 3, member B 103 engages in the offer (e.g., the same offer presented to A 102). The benefit to A 102 will now be increased by a cashback due to member B 103 purchasing the offer. To illustrate further, assume that the offer that was originally made to A 102 was for a 10% discount off of retail. When B 103 engages in the offer, the discount to A 102 may rise from 10% to (as an example) 15% (e.g., so member A 102 receives an electronic cash back of 5%). Also as a result of member B 103's purchase, member C 104 also receives the same offer that was given to member A 102 and member B 103, since member C is connected to member B. At stage 4, member C 104 purchases the offer as well. Because member A 102 started the chain, the discount for member A 102 may rise now from 15% to (as an example) 20%. Also as a result of member C 104 purchase, the discount for member B 103 may now have risen from 10% to 15%.

The model explained in the example above can be referred to as a chain model approach. The system can be configured to use other approaches. In the hub and spoke approach, for example, the discount for member A 102 would not have increased when member C 104 engaged in the offer because member C 104 is a level 2 connection to member A 102. In the hub and spoke model, members may only benefit from a level one connection that engages in the offer.

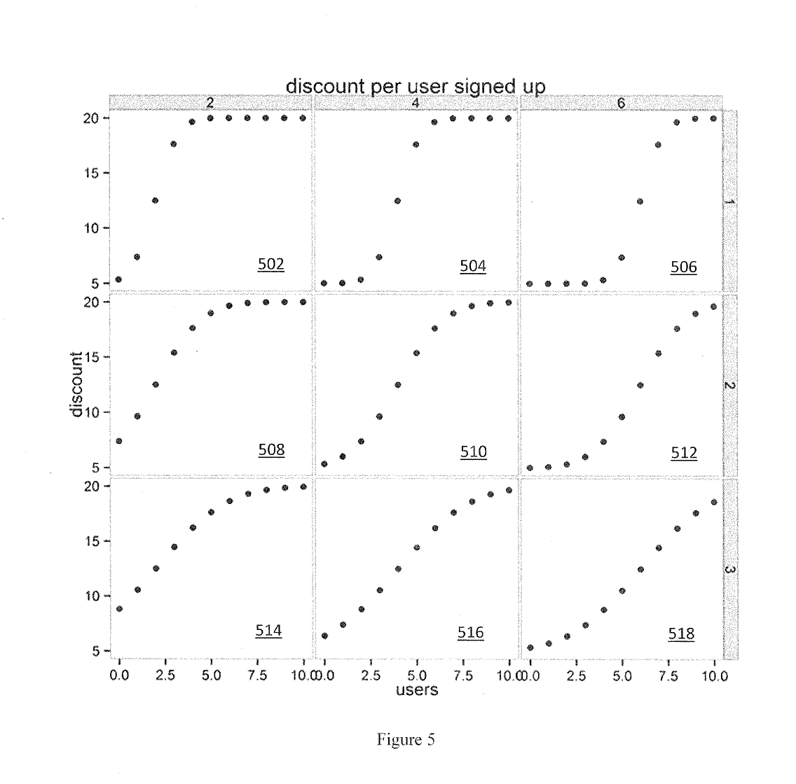

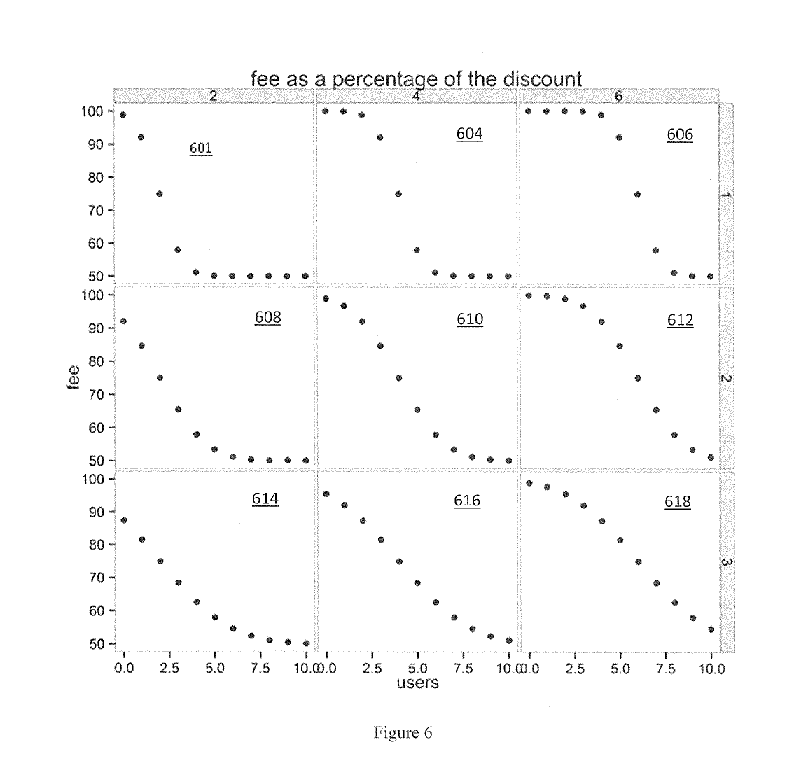

In some embodiments, the system utilizes non-decreasing mathematical functions that map the real line into the interval from 0 to 1. This function is then scaled and shifted to get into the discount range that is to be covered as members increase their level of influence. Some exemplary discount curves based on the normal cumulative distribution function are illustrated in FIGS. 5 and 6, described further below. CDFs can make good candidates for these functions, but other methods can be used. For example, nonnegative CDF mapping the natural numbers (including the Poisson distribution) also make good candidates, but may not have as many degrees of freedom in some cases. Another candidate is the CDF of the empirical distribution of some observation that is specified. This can allow for the most customizability and subsequently the most attention. The normal CDF is a candidate because it has two very simple parameters that are easy for people to understand which are referred to as shift and slope (commonly denoted in mathematics as μ and σ). Adjusting these parameters allows influence of the member psyche to increase member incentive to participate by supporting products that they enjoy. As an example, see further work done by Nobel Prize winner Daniel Kahneman in his 2000 book “Choices, Values and Frames,” which is hereby incorporated by reference herein in its entirety.

FIG. 5 is an exemplary chart of possible discount curves for users based on a normal cumulative distribution function (CDF) with different values for μ and σ, according to some embodiments. FIG. 5 shows discount curves 502, 504, 506, 508, 510, 512, 514, 516 and 518. Each discount curve has a different value of μ and σ to show a different curve relating the amount of discount (on the left axis) to the number of users that make a purchase (on the bottom axis). For example, discount curve 502 has values 2 and 1. FIG. 6 is an exemplary chart of possible fee structures for merchants based on the normal CDF with different values for μ and σ corresponding to the values from FIG. 5, according to some embodiments. FIG. 6 shows discount curves 601, 604, 606, 608, 610, 612, 614, 616 and 618. Each discount curve has a different value of μ and σ, as shown in FIG. 5, to show a different curve relating the fee to the user (on the left axis) to the number of users that make a purchase (on the bottom axis).

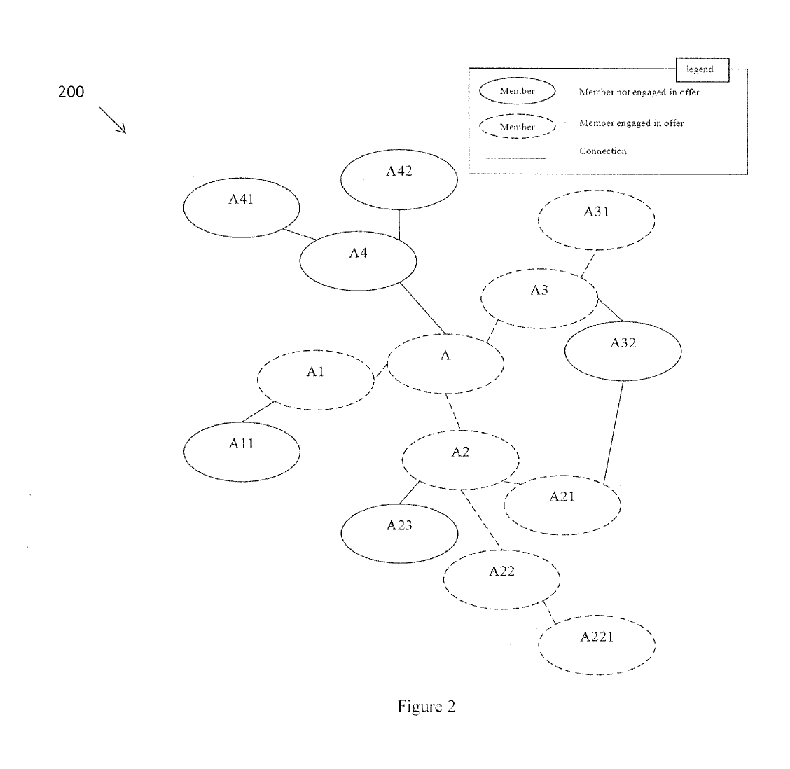

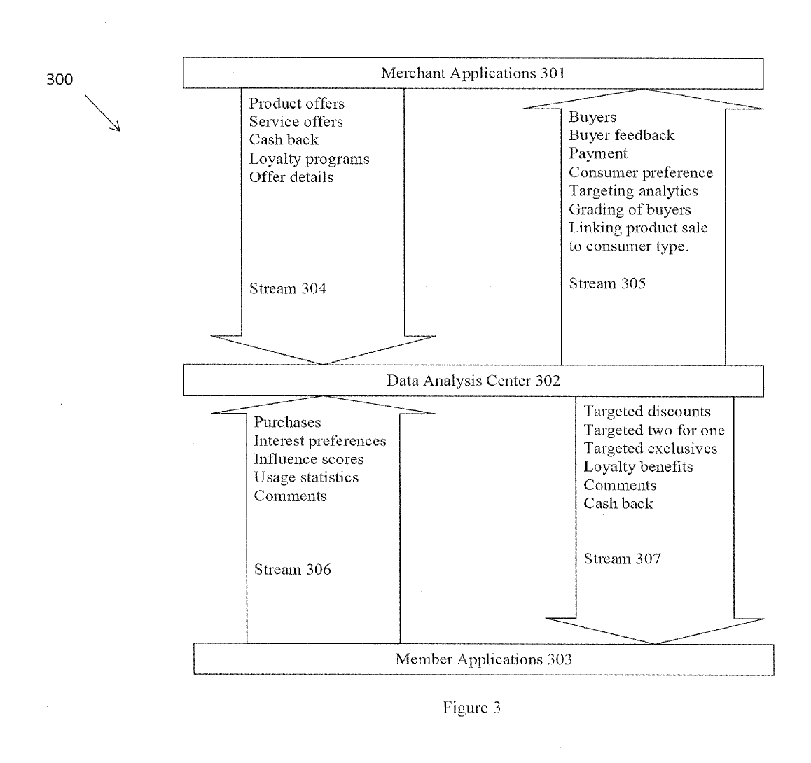

A CDF discount curve system can allow users to engage the deeper thinking system which is often quite overconfident and can be more engaging with offers made to them. For instance, a potential adjustment of the discount curve would be that the user gets no additional discount until their influence score reaches four (such an example may be seen in row 1 column 2 of FIG. 6, indicated by 601). At this point the user would experience a very steep ascent up the discount curve from five percent off in this case to twenty percent off with the next three users influenced until reaching the maximum benefit of twenty percent off. In this way, the users have strong incentive to have other users to participate by supporting products they already enjoy in a forum where that is not just acceptable but also encouraged. Influential Members (e.g., FIG. 2 and FIG. 3)

In some embodiments, the system can be configured to leverage its most influential members, such as described in conjunction with FIGS. 2 and 3, described further below. These influential members can drive deals by acting on them frequently and receive the best benefits by influencing the most members.

FIG. 3 is an exemplary flow diagram 300 that demonstrates the stream of information between the layers of the system, according to some embodiments. Stream 304 includes information that can flow into the data analysis center 302 from the merchant applications 301, including product offers, service offers, cash back, loyalty programs, and offer details. Stream 305 includes information that can flow from the data analysis center 302 to the merchant applications 301, including buyers, buyer feedback, payment, consumer preference, targeting analytics, grading of buyers, and linking product sale to consumer type. Stream 306 included information that can flow from the member applications 303 to the data analysis center 302, and can include purchases, interest preferences, influence scores, usage statistics, and comments. Stream 307 includes information that can flow from the data analysis center 302 to the member applications 303 including targeted discounts, target two for one, targeted exclusives, loyalty benefits, comments and cash back.

For example, through Merchant Applications 301, merchants can submit a query to Data Analysis Center 302 to find information from Stream 306 that can be obtained from members via Member Applications 303. Stream 307 information can then be distributed to Member Applications 303, resulting in Stream 305 information being sent back to Merchant Applications 301. This approach can lead to a virtuous cycle in that a member increasing their influence score leads to more deal drops and more early action thus higher discounts. Higher discounts granted lead to more deal actions and so on. The scoring for the influence may be implemented as a moving average process exponentially weighted, simply weighted, median or otherwise of the last N scores of influence. There also may be a time decay of influence with constant or variable force. The time decay can serve to reduce the influence score of inactive users by discounting their influence over time by some force r so that the influence of the user in the next day is influence divided by the quantity one minus the quotient of r and 365 (r can be an annualized rate compounded daily). The parameter r is often referred to as the time decay rate of influence.

The influential members may be suggested to merchants in their area or area of interest. This would be useful because it creates a virtuous cycle in which influential members become more influential. A concern here is one of starvation of the no-influence members. This concern can be solved by seeding them with offers that merchants don't make to them directly. This way, if there isn't enough content to show to any given member the system can show them things in the order of relevance to that member.

In some embodiments, the system can be configured using an artificial intelligence (“AI”) system (e.g., based on collected data on the member activity). The AI system can accept as inputs of the time series of the chain scores, number of first degree connections, and offer action percentage among potentially others.

FIG. 2 is an exemplary schematic diagram 200 of a collection of members rooted at member A interacting with an offer, according to some embodiments. Therefore FIG. 2 shows a universe of the user A. Each oval represents a user and the solid lines indicate this user has not engaged in the offer while the dashed lines indicate this user has engaged in the offer. The naming convention is the first digit is a first level connection to A and uniquely identifies this user in that group. The second digit is relative to the first and identifies that user within the first level subgroup and so on. A is a member which is engaged in the offer with the connections of A being engaged and not engaged. The influence score of A for this offer is seven. It is simply found by counting the number of direct and indirect connections that A influenced to act on this offer, which are all of the members of A with dashed lines, namely A1, A2, A21, A22, A221, A3, and A31.

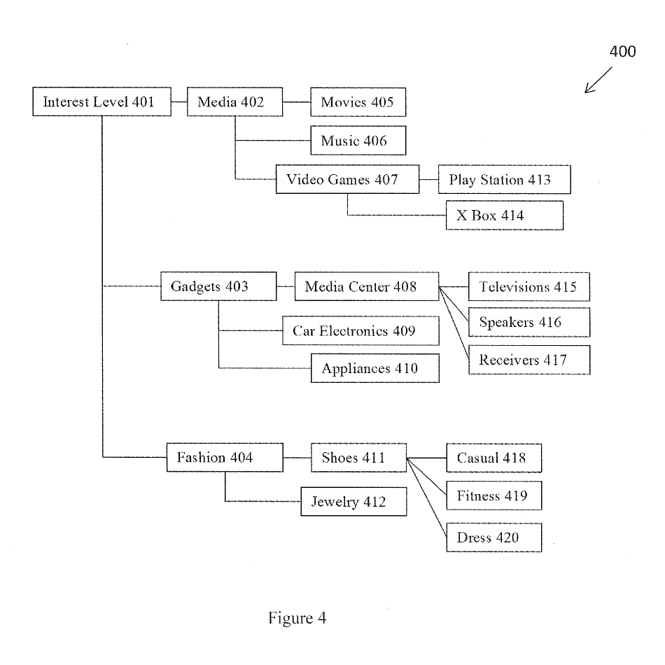

In some embodiments, the interest mapping feature of the system is the basis for the distribution of offers by merchants. This technology can inform merchants of the members which are most likely to want to engage in their offers. In some embodiments, the basis for this technology is a tiered probability tree. FIG. 4 is an exemplary diagram of a potential interest tree 400 to which the system can assign probabilities of interest, according to some embodiments. Interest level 401 includes media 402, gadgets 403 and fashion 404. Media 402 includes movies 405, music 406, and video games 407. Video games 407 includes PlayStation 413 and X Box 414. Gadgets 403 includes media center 408, car electronics 409 and appliances 410. Media center 408 includes televisions 415, speakers 416 and receivers 417. Fashion 404 includes shoes 411 and jewelry 412. Shoes 411 includes casual 41

Each of the cells in FIG. 4 can be assigned a probability. This probability can be represented as a number between 0 and 1 which can be used as the probability of a member being interested in an offer within that node. The tree structure can be useful, as demonstrated by the example in FIG. 4. For example, if it is known that the member is less (more) interested in shoes 411 the system can decrease (increase) the probability that the individual is interested in all kinds (418, 149 and 420) of shoes. Subsequently when the user makes the system aware that the user does (does not) like seeing offers about fitness 419 shoes specifically, the system can increase (decrease) the probability for this specific node 419 and not its parent 411.

This can allow the system to finely control which offers get sent to which members and give merchants a powerful targeted advertising toolbox. This is targeted advertising by voluntary self-selection. An exemplary difference between this system and a tagging system is the hierarchal structure allows better maintenance of information and a greater leveraging of each data point. This kind of data structure also allows showing interaction of member preferences and discovery of what users' true interests are.

The exemplary discount structures methods demonstrated in FIGS. 1 and 2 could be extended, for example to all point of sale transactions. For instance if this system were utilized as an intermediary between the customer and their credit card or bank account, it could offer benefits that the user was completely unaware before the purchase. These offers would of course be only targeted based on who the users are connected to or if these users are designated as influential and interested users for that merchant. Users in this instance would immediately receive the applicable discount.

The loyalty system can replace existing customer loyalty cards and programs. It can eliminate the need for merchant's to maintain databases full of customers and instead have such information maintained within the system. It also provides an alternative method for members to join loyalty programs.

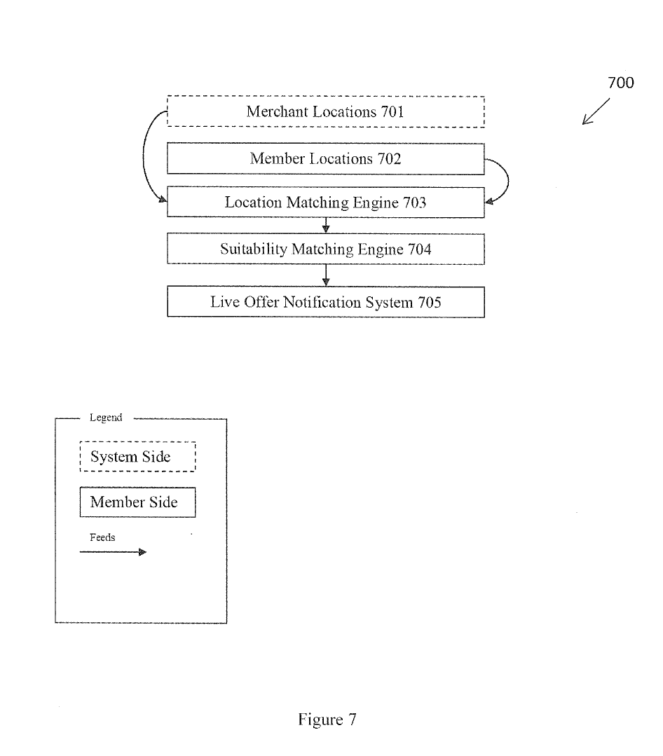

In some embodiments, the system can use location-based targeting. The location based targeting system can be described as a number of subsystems. FIG. 7 is an exemplary diagram 700 that depicts the system's use of location based targeting, according to some embodiments. In some embodiments as shown in FIG. 7, the merchant locations system 701 can be the stored on the system side indicating that this information need not be stored locally with the user. In some embodiments, the merchant locations system 701 is in a cloud location. In some embodiments, if the system is not designed to track its users, all user location data can be processed on the user side, thus, with the user and not in a cloud location. For example, the member locations system 702 is fully contained on the member application side. These two systems can provide feeds to the location matching engine 703. The location matching engine 703 determines if: (a) the user is near a location which is a system participant or (b) the user is heading toward one of these locations. If this is deemed to be the case by the matching engine 703, the matching engine feeds the merchant name, type, and positional location to the suitability matching engine 704. This engine determines if this user would in fact be interested in anything that this merchant has to offer utilizing the interest trees described previously. If this is deemed to be the case, the live offer notification system 705 is fed with the information of the specific interesting offer(s), merchant information and location of merchant information. The live offer notification system 705 then informs the user of this information and offers directions to the location of the offer.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of nonvolatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. A computerized method for social network connection-driven product promotion, comprising:
receiving, by a computing device, data from a first remote computing device indicative of a purchase of an offer from a merchant, wherein the data is associated with a user and includes a purchase price for the offer;
determining, by the computing device, a set of social network contacts of the user based on a social network for the user stored in a database in communication with the computing device;
updating, by the computing device, data associated with a set of user accounts for one or more contacts from the set of social network contacts stored in the database to include the offer from the merchant, so that a user associated with an updated user account is presented with the offer from the merchant;
receiving, by the computing device, second data from a second remote computing device indicative of a second purchase of the offer from the merchant, wherein the second data is associated with an updated user account from the set of user accounts; and
adding, by the computing device, a credit for a portion of the purchase price to a user account associated with the user so that the purchase price paid by the user is reduced in response to the second purchase by a contact from the set of social network contacts of the user.

2. The method of claim 1, further comprising:
determining a second set of social network contacts of a second user associated with the updated user account based on a second social network for the second user stored in the database; and
updating data associated with a second set of user accounts for one or more contacts from the second set of social network contacts stored in the database to include the offer from the merchant, so that a user associated with an updated second user account is presented with the offer from the merchant.

3. The method of claim 2, further comprising receiving third data from a third remote computing device indicative of a third purchase of the offer from the merchant, wherein the third data is associated with an updated user account from the second set of user accounts.

4. The method of claim 3, further comprising adding a second credit for a second portion of the purchase price to the user account so that the purchase price paid by the user is reduced in response to the third purchase by a contact from the second set of social network contacts of the second user.

5. The method of claim 3, further comprising adding a second credit for a second portion of the purchase price to the second user account so that the purchase price paid by the second user is reduced in response to the third purchase by a contact from the second set of social network contacts of the second user.

6. The method of claim 1, wherein adding the credit to the user account comprises:
determining, based on the second purchase and any other purchases of the offer by members from the user's social network, that a predetermined threshold number of sales to qualify for a credit has been satisfied for the user.

7. A computing system configured to provide social network connection-driven product promotion, comprising:
a database; and
a processor in communication with the database, and configured to run a module stored in memory that is configured to cause the processor to:
receive data from a first remote computing device indicative of a purchase of an offer from a merchant, wherein the data is associated with a user and includes a purchase price for the offer;
determine a set of social network contacts of the user based on a social network for the user stored in the database;
update data associated with a set of user accounts for one or more contacts from the set of social network contacts stored in the database to include the offer from the merchant, so that a user associated with an updated user account is presented with the offer from the merchant;
receive second data from a second remote computing device indicative of a second purchase of the offer from the merchant, wherein the second data is associated with an updated user account from the set of user accounts; and
add a credit for a portion of the purchase price to a user account associated with the user so that the purchase price paid by the user is reduced in response to the second purchase by a contact from the set of social network contacts of the user.

8. The computing system of claim 7, wherein the module stored in memory is configured to cause the processor to:
determine a second set of social network contacts of a second user associated with the updated user account based on a second social network for the second user stored in the database; and
update data associated with a second set of user accounts for one or more contacts from the second set of social network contacts stored in the database to include the offer from the merchant, so that a user associated with an updated second user account is presented with the offer from the merchant.

9. The computing system of claim 8, wherein the module stored in memory is configured to cause the processor to receive third data from a third remote computing device indicative of a third purchase of the offer from the merchant, wherein the third data is associated with an updated user account from the second set of user accounts.

10. The computing system of claim 9, wherein the module stored in memory is configured to cause the processor to add a second credit for a second portion of the purchase price to the user account so that the purchase price paid by the user is reduced in response to the third purchase by a contact from the second set of social network contacts of the second user.

11. The computing system of claim 9, wherein the module stored in memory is configured to cause the processor to add a second credit for a second portion of the purchase price to the second user account so that the purchase price paid by the second user is reduced in response to the third purchase by a contact from the second set of social network contacts of the second user.

12. The computing system of claim 7, wherein adding the credit to the user account comprises:
determining, based on the second purchase and any other purchases of the offer by members from the user's social network, that a predetermined threshold number of sales to qualify for a credit has been satisfied for the user.

13. A non-transitory computer readable medium having executable instructions operable to cause an apparatus to:
receive data from a first remote computing device indicative of a purchase of an offer from a merchant, wherein the data is associated with a user and includes a purchase price for the offer;
determine a set of social network contacts of the user based on a social network for the user stored in the database;
update data associated with a set of user accounts for one or more contacts from the set of social network contacts stored in the database to include the offer from the merchant, so that a user associated with an updated user account is presented with the offer from the merchant;
receive second data from a second remote computing device indicative of a second purchase of the offer from the merchant, wherein the second data is associated with an updated user account from the set of user accounts; and
add a credit for a portion of the purchase price to a user account associated with the user so that the purchase price paid by the user is reduced in response to the second purchase by a contact from the set of social network contacts of the user.

14. The non-transitory computer readable medium of claim 13, having executable instructions operable to cause the apparatus to:
determine a second set of social network contacts of a second user associated with the updated user account based on a second social network for the second user stored in the database; and
update data associated with a second set of user accounts for one or more contacts from the second set of social network contacts stored in the database to include the offer from the merchant, so that a user associated with an updated second user account is presented with the offer from the merchant.

15. The non-transitory computer readable medium of claim 14, having executable instructions operable to cause the apparatus to receive third data from a third remote computing device indicative of a third purchase of the offer from the merchant, wherein the third data is associated with an updated user account from the second set of user accounts.

16. The non-transitory computer readable medium of claim 15, having executable instructions operable to cause the apparatus to add a second credit for a second portion of the purchase price to the user account so that the purchase price paid by the user is reduced in response to the third purchase by a contact from the second set of social network contacts of the second user.

17. The non-transitory computer readable medium of claim 15, having executable instructions operable to cause the apparatus to add a second credit for a second portion of the purchase price to the second user account so that the purchase price paid by the second user is reduced in response to the third purchase by a contact from the second set of social network contacts of the second user.

18. The non-transitory computer readable medium of claim 13, wherein adding the credit to the user account comprises:
determining, based on the second purchase and any other purchases of the offer by members from the user's social network, that a predetermined threshold number of sales to qualify for a credit has been satisfied for the user.
